(19) United States
(12) Patent Application Publication
(10) Pub. No.: US 2012/0258229 A1
(43) Pub. Date: Oct. 11, 2012

(54) Method and Apparatus for Cooking Pizza

(76) Inventor: Jef Mindrup, Dallas, TX (US)

(21) Appl. No.: 13/444,634

(22) Filed: Apr. 11, 2012

Related U.S. Application Data
(60) Provisional application No. 61/474,038, filed on Apr. 11, 2011.

(51) Int. Cl. H05B 3/68; A21D 13/08

(52) U.S. Cl. 426/556; 219/450.1

(57) ABSTRACT

A pizza is prepared while it is constructed using a novel process and device. Dough is placed onto a thermal mass, followed by the use of a handheld very high heat source to sear the top surface of the dough. As the pizza dough remains in contact and continues to bake on the thermal mass, toppings are added. The toppings and dough can be selectively seared with the handheld device, and/or allowed to temper with or without the aid of a lid. The lid has a low profile and flat top and creates a minimal cooking volume when placed over the thermal mass. The searing occurs in sections and allows the pizza cook to selectively cook, char, comingle and caramelize the toppings and dough of the pizza.

### CROSS-REFERENCE TO RELATED APPLICATIONS

This application is a non-provisional of provisional application Ser. No. 61/474,038 filed on Apr. 11, 2011.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of apparatuses and processes used to prepare food. More particularly, the present invention is in the technical field of the apparatuses and processes used to prepare pizza at high temperatures. The traditional process used to make a pizza typically includes pressing a measure of dough into a flat shape, covering the dough with various ingredients, and then inserting the assembled pizza into a large heating cavity such as a wood burning, coal, gas or electric oven. The oven may further include a feature that moves the pizza through the oven. In some cases prior to being inserted into the oven, the pizza is prepared in or on a pan and then the pan is inserted into the oven, and then removed after cooking.

The oldest and most traditional method of cooking pizza includes the use of a wood burning oven or hearth oven. A fully assembled pizza typically made of flattened dough covered with a sauce and toppings is inserted as a single assembled item into a wood burning oven or hearth. The assembled pizza is then exposed to the heat within the oven cavity for the duration of the cooking process.

This traditional method requires a high degree of skill and experience to fully cook all of the ingredients and the dough of the pizza evenly. Most often chefs are forced to make compromises by either undercooking or overcooking areas or the entirety of the pizza due to the extreme temperature variations of several hundred degrees Fahrenheit within the wood burning oven or hearth. The resulting compromises may create any combination of burnt or undercooked bottoms, soggy doughy centers as well as over charred to burnt crusts (cornices). Further, optimization of the desired attributes of searing, comingling of ingredients, caramelization, and charring of the cornice are also subject to the same variable heat differences inherent in the wood burning oven or hearth.

Wood burning ovens and hearths are expensive to build, maintain and clean. They are especially wasteful of energy as they heat up a great expanse of air volume and the oven itself. Additionally, an immense amount of heat is lost in the wood burning oven or hearth via the exhaust flue or chimney. As well, wood burning ovens and hearths require constant addition of fuel in the form of wood or coal and in modern hybrid models that also use or supplement with electric or gas energy.

There exists a need for a low-cost, efficient and smaller option for making pizzas that have the same desired characteristics as pizzas made in the high temperatures of a wood burning oven or hearth without any of the faults inherent in the use of the traditional process and apparatus outlined above. Some options presented by others to address this need include the table top baking oven described in U.S. Pat. No. 5,315,922, the rotatable cooking apparatus of U.S. Pat. No. 6,125,740, and the high temperature bake oven of U.S. Pat. No. 7,686,010. However, the presented solutions have various deficiencies including the inability to achieve the high heat of a hearth or wood burning oven, the presence of wide temperature variations within the cooking cavity, and are expensive to purchase and maintain. Lastly, the previous solutions are larger, heavier and use more energy than the solution presented here.

### SUMMARY OF THE INVENTION

The present invention is an apparatus and process to make pizzas using high temperatures and a handheld very high heat device. The process and equipment described by the inventor create a pizza that has the unique and flavorful traits of a pizza created in a wood burning oven or hearth, without the drawbacks of using a wood burning oven or hearth. The presented solution uses a handheld device such as a torch or infrared emitter capable of very high heat output. Handheld devices enable chefs to precisely apply very high heat to create intermittent charring of the crust and cornice as well as caramelization and searing of the toppings.

Throughout the charring and searing process the dough cooked by a flat thermal mass that the dough is resting on. The use of a flat thermal mass, and the application of very high heat using a handheld device during the cooking process, allows the pizza chef to construct the pizza as it cooks, thus, the chef may maintain a high degree of artistry to maximize the flavor profile and integration of flavors of the pizza ingredients.

Unique and novel to this process is the ability to construct a pizza as the dough continuously cooks on the thermal mass coupled with the unfettered access created by the apparatus designed to allow the intermittent application of a handheld very high heat device to effectively cook, sear, char, comingle and caramelize the sauces, toppings and cornice of the pizza to a degree of specialization that all previous pizza cooking processes and apparatus are incapable of.

As a result of this novel process and the apparatus, the chef maintains the unique ability to control the moisture in the final product. Even at experienced and highly regarded pizzerias throughout the world, pizza consumers often experience uncooked soggy dough centers and tip sag, burnt crusts, overcooked and undercooked areas of the pizza and or toppings. At times, two or more or even all of these flaws are present to some degree on the same pizza.

The present invention includes the process of placing the dough onto a thermal mass, followed by the application of very high heat to the top surface of the dough using a handheld device such as a blow torch, or infrared emitter. This searing process of the dough's top surface seals the dough and limits the comingling of the topping's moisture into the dough. As the pizza dough remains in contact and continues to bake on the thermal mass the toppings are added. These toppings can either be immediately subjected to the handheld very high heat source or first allowed to temper, either with or without the aid of a lid, and then subjected to the very high heat source. The degree of application of the very high heat source to the pizza can be influenced precisely to the ingredients, and the chef's and consumer's tastes.

### BRIEF DESCRIPTION OF THE DRAWINGS

FIG. 1 is a perspective view of an apparatus used to prepare pizza;

FIG. 2 is a perspective view of an apparatus used to prepare pizza;

FIG. 3 is a perspective view of a step of a pizza preparation process;

FIG. 4 is a perspective view of a step of a pizza preparation process;

FIG. 5 is a perspective view of a step of a pizza preparation process;

FIG. 6 is a perspective view of a step of a pizza preparation process; and,

FIGS. 7a-7e are flowcharts describing the claimed process.

### DETAILED DESCRIPTION OF THE INVENTION

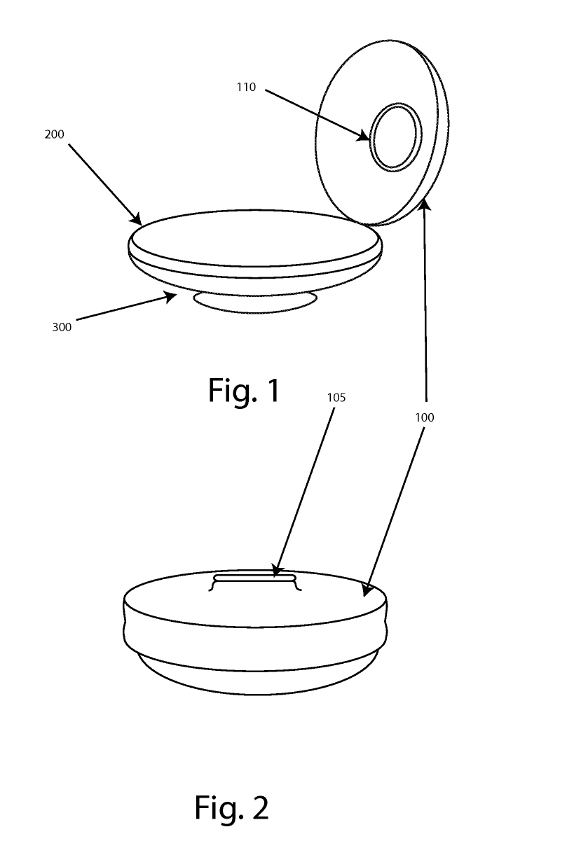

Referring now to the invention in more detail, in FIG. 1 there is shown an apparatus. The apparatus includes base unit 300, thermal mass 200, and lid 100. Also shown in FIG. 1 is heating element 110 that may be used to carry out the invention by adding additional heat to the cooking volume created when lid 100 is placed over or onto thermal mass 200.

Still referring to the invention shown in FIG. 1, base 300 is shown. Base 300 is defined by its ability to support thermal mass 200. Further, base 300 may house the necessary means to provide energy to heat thermal mass 200 up to the desired temperatures. In the preferred embodiment base 300 is insulated.

Still referring to the invention shown in FIG. 1, thermal mass 200 is shown. Generally, thermal mass 200 is a cooking surface with a flat top. Thermal mass 200 has the ability to be heated, and is preferably massive enough to retain high heat during the cooking process. Thermal mass 200 may be heated by any means including but not limited to electric or gas. The heating means may be integrated into thermal mass 200, or may be part of base 300. In the preferred embodiment, and shown in the figures, thermal mass 200 rises above base 300 so that an ordinary pizza peel may be used to remove a pizza from thermal mass 200 without interference from base 300. Further, thermal mass 200 has the ability to be heated to at least 800 degrees Fahrenheit.

Referring now to both FIG. 1 and FIG. 2, lid 100 is shown. Lid 100 is a removable cover that fits over thermal mass 200, or rests on top of thermal mass 200. Lid 100 may be attached to base 300 by a hinge, or any other means, or may be removable. Preferably, lid 100 is insulated, such that the outside surfaces of lid 100 are safe to touch, and so that thermal mass 200 may retain more heat when lid 100 is placed above it as shown in FIG. 2. Lid 100 may also include a heating unit 110. Further, referring to both FIG. 1 and FIG. 2 there are shown two different shapes for the apparatus. The preferred embodiment is shown in FIG. 2, where the top of lid 100 is flat and generally parallel to the cooking surface of thermal mass 200 so that radiant heat from thermal mass 200 is evenly redirected back onto the cooking surface, or if the cooking surface is in use, back onto the food being prepared. FIG. 1, showing an open apparatus shows the inside top surface, which is preferable flat and parallel to the top surface of the thermal mass. Additionally, in the preferred embodiment the interior surfaces of lid 100 are reflective to aid in the insulation of lid 100. Also shown in FIG. 2 is lid 100 having a general height that is slightly taller than the height of a standard pizza. This feature minimizes the interior cooking volume of the apparatus creating the benefit, among other things, of faster cooking. The apparatus is not limited by the shapes shown, the apparatus may be square, rectangular, octagonal, or any other shape capable of carrying out the invention.

Still referring to FIG. 1, heating unit 110 may be used. Heating unit 110 may use electric, gas or any other heating means to provide heat to the interior cooking volume of the apparatus shown. Referring to FIG. 2, handle 105 is shown for removal and placement of lid 100.

In summary, FIG. 1 and FIG. 2 show an apparatus that has a large thermal mass, and a lid that can be removed from the thermal mass to allow for direct access to the thermal mass.

The construction details of thermal mass 200 are that it is preferably fired ceramic stone, but may be a composite aggregate, a metallic alloy, or any material capable of being heated and used to prepare food. In the preferred embodiment, thermal mass 200 may be heated up to 800 degrees Fahrenheit. Depending on material and size, thermal mass 200 typically weighs between 3 and 10 lbs.

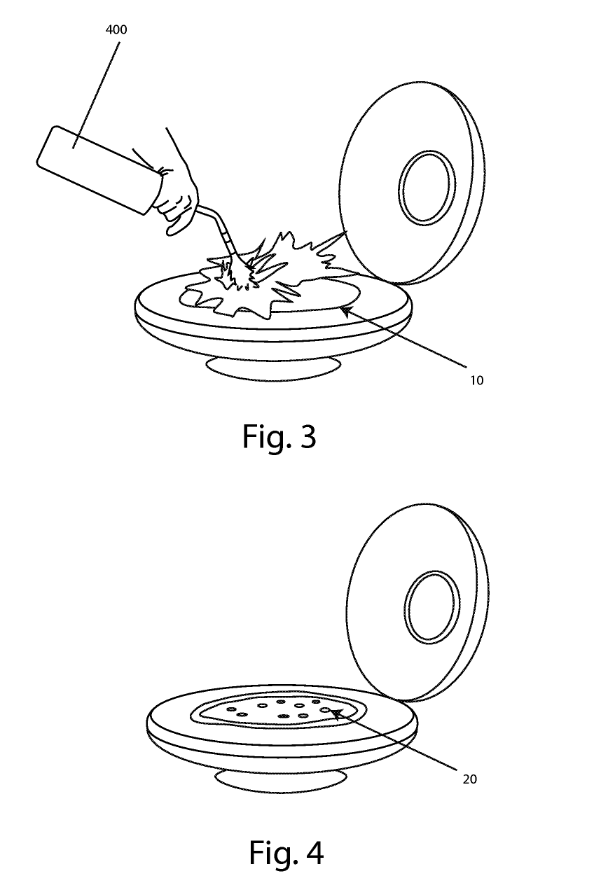

Referring now to the invention shown in FIG. 3, handheld heating device 400 is shown. The handheld heating device 400 shown in the figures is a handheld device that emits a jet of hot gas. In the preferred embodiment, handheld heating device 400 is a standard commercially available torch that uses flammable gases such as propane, butane or other mixes of flammable gases capable of providing very high heat in excess of 1,100 degrees Fahrenheit or greater. In the preferred embodiment, handheld heating device 400 is a free, separate object. Handheld heating device 400 may be an electric infrared or near infrared emitter, a handheld torch, or a gas fed heating device, or any other device capable of producing very high heat. Table 1 is a manufacturer's published specification from a standard off-the-shelf torch unit that can be used to carry out the invention. Thus, in one embodiment of the invention, handheld heating device 400 is directly applying a flame that has a temperature in excess of 3,000 degrees Fahrenheit.

TABLE 1

| | | | Max Power |
|---|---|---|---|
| | Butane | Propane | Propylene |
| Flame Temperature in Oxygen | 4,925 | 4,579 | 5,193 |
| (° F.) | | | |
| Flame Temperature in Air | 3,200 | 3,450 | 3,600 |
| (° F.) | | | |
| Burning Velocity in Oxygen | 11.0 | 12.2 | 15.0 |
| (Ft/Sec) | | | |
| Total Heating Value | 3,374 | 2,498 | 2,371 |
| (BTU/CuFt) | | | |
| Primary Combustion | 315 | 255 | 433 |
| Heating Value (BTU/CuFt) | | | |
| Secondary Combustion | 3,114 | 2,243 | 1,938 |
| Heating Value (BTU/CuFt) | | | |
| Total Heating Value After | 21,500 | 21,800 | 21,100 |
| Vaporization (BTU/lb) | | | |
| Auto Ignition Temperature | 860 | 874 | 927 |
| (° F.) | | | |
| Volume to Weight Ratio | 6.40 | 8.66 | 8.25 |
| (CuFt/lb) | | | |
| Specific Gravity of Gas in Air | 2.076 | 1.520 | 1.480 |
| Specific Gravity of Gas in | 0.579 | 0.507 | 0.522 |
| Liquid | | | |
| Pounds Per Gallon | 4.70 | 4.24 | 4.35 |
| Oxygen Required, Neutral | N/A | 4.3 | 3.5 |
| Flame (CuFt/Ft Fuel) | | | |
| Explosive Limits in Air (%) | 1.9-8.5 | 2.2-9.5 | 2.0-11.0 |
| Toxicity | Low | Low | Low |
| Shock Sensitivity | Stable | Stable | Stable |
| Tendency to Backfire | Slight | Slight | Slight |
| Reactions to Backfire | Few | Few | Few |
| | Restrictions | Restrictions | Restrictions |
| Vapor Pressure @70° F. | 30 | 125 | 140 |

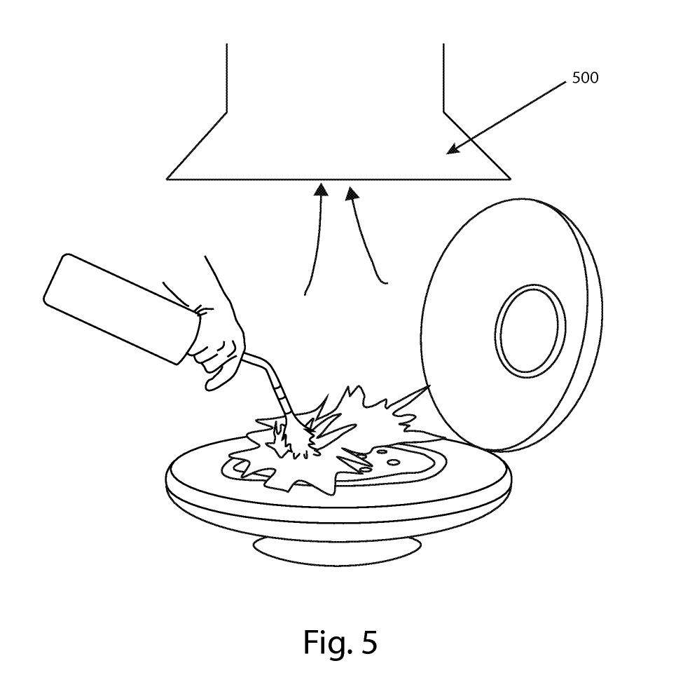

FIG. 3 and FIG. 5 show the application of ultra-high heat using handheld heating device 400 to the top of a layer of dough 10, and to the cornice of pizza 20 while thermal mass 200 provides heat to the bottom of dough 10 and pizza 20. This is the general cooking process, coupled with intermittent use of lid 100, and as seen in the figures, the application of heat with handheld device 400 occurs in sections; the entire pizza is not subjected to the ultra-high heat at the same time, allowing the chef to be selective with searing, charring and caramelization.

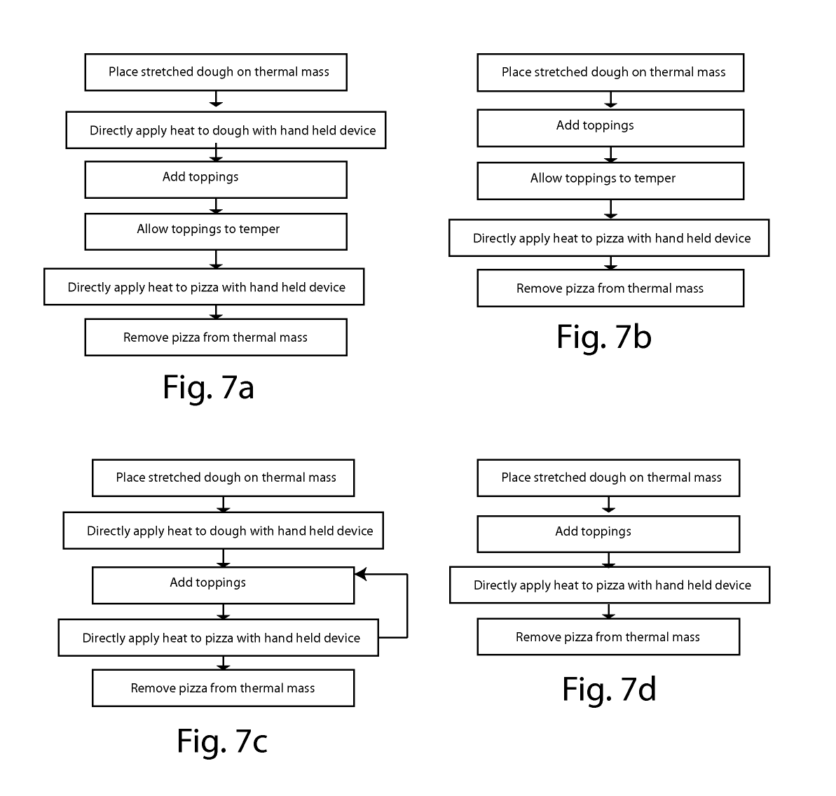

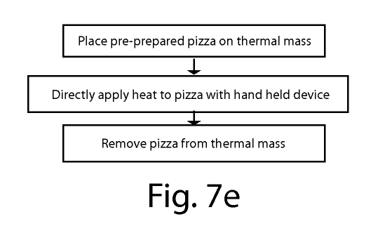

Referring now to FIG. 4, toppings 20 are added on top of dough 10. Toppings 20 may include anything suitable for human consumption including liquids, such as sauces, and solids such as pepperoni. In the preferred embodiment, lid 100 is placed over the pizza and an appropriate period of time passes while the ingredients temper to a higher temperature in preparation for exposure to the direct heat applied by handheld heating device 400. The amount of tempering time is variable depending the type and mass of the ingredients, their starting temperature, the temp of the thermal mass, and the desired effect for each finished pizza. Although not shown in FIGS. 7c, 7d, or 7e, the lid may be used as described above in any embodiment if necessary or desired.

Next, handheld heating device 400 is used to directly apply heat and sear dough 10 and toppings 20 and finish the charring effect on the cornice. After the pizza is cooked, it is removed from thermal mass 200 and the process is complete.

Referring now to FIG. 5, vent means 500 is shown. In some cases, due to varying local fire codes, a method of ventilation may be required to carry out the present invention. Ventilation means 500 can be any apparatus capable of moving air and meeting the local fire code and ordinances.

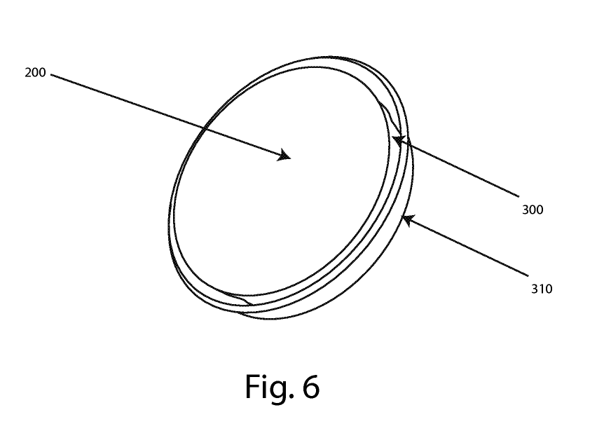

Referring now to the invention shown in FIG. 6, outer base 310 is shown. In this embodiment, base 300 is separated from outside base 310 for insulation and safety reasons.

Referring now to FIGS. 7a through 7e, flowcharts describe different processes for preparing pizza. The process begins by placing stretched pizza dough 10 onto thermal mass 200. In the preferred embodiment, handheld heating device 400 is used to directly apply heat to dough 10. (FIGS. 7a and 7c) This seals the top of the dough and prevents the absorption of pizza toppings into the dough. In another embodiment of the invention, handheld heating device 400 is not used to seal dough 10 (FIGS. 7b and 7d). In another embodiment, the wholly prepared pizza is delivered to the thermal mass (FIG. 7e). Further, FIG. 7c shows an additional option of adding a series of layers of toppings and searing each layer. This option may be used when particular toppings are added that require disparate cooking times. Although not shown in the other figures, this iterative process of adding toppings, searing toppings, and adding additional toppings may be implemented in any of the processes shown.

The advantages of the present invention include, without limitation, the ability to prepare unique pizzas using high temperatures at a reduced cost and an easy learning curve. The high temperatures allow for very thin crust pizzas and provide a unique flavor and eating experience. The charring effect associated with high heat wood burning ovens can be customized for each pizza, and pizza topping. The apparatus is small, portable, relatively inexpensive, and the process is relatively easy when compared to existing methods like a wood burning oven.

More specifically, the advantages include extremely low cost of equipment compared to wood burning ovens, hearths, and traditional pizza baking equipment capable of producing high baking temperatures that result in a particular type of pizza. Another advantage is the low cost of ownership and operation because the unit can warm up and cool down quicker, thus there is less energy used per cycle. Additionally, due to the intermittent use of a handheld device, less energy is wasted in comparison the methods of the prior art where the entire pizza is continuously exposed to high heat. Yet another advantage of the invention is the portability of the equipment, resulting in increased availability of locations that can produce a pizza that looks and tastes like it was made in an expensive oven, such as a wood burning oven or hearth.

An additional advantage is that pizzas made with this process improve when compared with traditional method. The crust is fully cooked without a wet or doughy center. Moisture wicking from the sauce to the dough is limited by the sealing of the pizza dough as it continually cooks. Ingredients can be targeted during the cooking process by the use of the handheld heat device. The construction process allows the greatest amount of flexibility in optimizing the cooking of disparate ingredients, for disparate durations and disparate temperatures.

In broad embodiment, the present invention is a process of constructing and cooking a pizza using a flat openly accessible thermal mass, with a removable or hinged insulated cover and a handheld very high heat device. Further, the present invention is an apparatus for carrying out the process.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A method of simultaneously cooking and constructing a pizza comprising at least the following steps:
heating a thermal mass;
placing a layer of dough on said thermal mass, wherein said layer of dough has a top side and a bottom side, and said bottom side is in contact with said thermal mass;
searing sections of said top side of said layer of dough with a handheld device that emits a jet of hot gas;
adding a layer of toppings to said top side of said dough;
searing sections of said layer of toppings and said top side of said layer of dough using said handheld device; and,
removing said dough and said toppings from said thermal mass.

2. The method of claim 1 wherein a lid is placed over said layer of dough and said layer of toppings, and said lid is removed before said layer of toppings is seared with said handheld device.

3. The method of claim 1 wherein said thermal mass is heated to a temperature between 550 and 950 degrees Fahrenheit before said layer of dough is added to said thermal mass.

4. The method of claim 1 further including the step of adding first toppings to said layer of dough before said searing sections of said top side of said layer of dough step, wherein said searing sections of said top side of said layer of dough step includes searing said first toppings.

5. The method of step 1 wherein said handheld device is a compressed-gas blow torch.

6. The method of step 1 wherein said jet of hot gas has an in-air flame temperature of at least 3,000 degrees Fahrenheit.

7. The method of step 1 wherein said jet of hot gas has an in-air flame temperature between 1,100 degrees Fahrenheit and 3,600 degrees Fahrenheit.

8. The method of claim 1 wherein said searing sections of said layer of toppings includes caramelizing and charring sections of said layer of toppings and said top side of said layer of dough.

9. The method of claim 1 wherein said layer of dough is a par baked pizza crust.

10. The method of claim 1 further including additional steps of adding additional layers of toppings and searing said additional layer of toppings before said layer of dough and said layer of toppings, and said additional layers of toppings, are removed from said thermal mass.

11. A method of using a handheld infrared emitter to prepare a pizza while the pizza is being constructed, said method comprising at least the following steps:
placing a layer of dough on a cooking surface, wherein said layer of dough has a top side and a bottom side and said bottom side is in contact with said cooking surface;
exposing said top side of said layer of dough to the heat produced by a handheld infrared emitter;
adding a layer of toppings to said layer of dough;
exposing said layer of toppings to the heat produced by a handheld infrared emitter;
removing said disc of dough and said layer of toppings from said cooking surface.

12. The method of claim 11 wherein said handheld infrared emitter emits in excess of 3,000 degrees Fahrenheit.

13. The method of claim 11 wherein said handheld infrared emitter is a halogen near-infrared shortwave emitter.

14. A device for cooking pizza comprising at least:
a base;
a thermal mass, supported by said base unit and positioned such that the top of said thermal mass extends above said base unit, wherein said thermal mass is capable of withstanding repetitive thermal cycling from ambient room temperature to at least 800 degrees Fahrenheit, and said thermal mass can withstand exposure to intermittent temperatures of at least 3,000 degrees Fahrenheit;
a heating element housed within said base unit and positioned to heat said thermal mass, wherein said heating element is capable of providing enough heat to raise the temperature of said thermal mass from ambient room temperature to at least 800 degrees Fahrenheit;
a removable cover having a handle wherein the inside top surface of said removable cover is generally flat.

15. The device of claim 14 wherein said inside top surface is no greater than three inches from said thermal mass when said removable cover is placed over said thermal mass.

16. The device of claim 14 wherein said removable cover is insulated, and the inside surfaces of said removable cover are reflective.

17. The device of claim 14 further comprising an insulated outer base wherein said base is positioned inside said outer base.

18. The device of claim 14 wherein said removable cover is attached to said base unit with a hinge.

19. The device of claim 14 wherein said removable cover includes a heating element positioned in the inside of said removable cover.

20. The apparatus of claim 14 wherein the thermal mass weighs between 3 and 10 pounds.
